(19) United States
(12) Patent Application Publication
(10) Pub. No.: US 2026/0284757 A1
(43) Pub. Date: Sep. 24, 2026

(54) MILLING AND/OR GRINDING TOOL AND TURNING PROCESS USING A MILLING AND/OR GRINDING TOOL

(71) Applicant: Franken GmbH & Co. KG, Rückersdorf (DE)

(72) Inventors: Helmut GLIMPEL, Lauf a.d. Pegnitz (DE); Andreas KIRSCH, Rosdorf (DE); Dieter AHRENS, Rückersdorf (DE)

(21) Appl. No.: 19/577,175

(22) Filed: Mar. 24, 2026

(30) Foreign Application Priority Data
Mar. 24, 2025 (DE) 102025111282.7

(51) Int. Cl. B23C 5/10; A61C 13/00

(52) U.S. Cl. CPC B23C 5/1009; A61C 13/0006; B23C 2210/0485; B23C 2210/202; B23C 2222/88; B23C 2226/18

(57) ABSTRACT

Milling and/or grinding tool, in particular a dental milling tool or dental grinding tool (10, 100), comprising a shaft (12, 120, 140) and a working part (14, 140), wherein the working part (14, 140) has at least one partially ball-shaped end face region (20, 200) and a section (18, 180) tapering toward the end face region (20, 200), in particular a conically shaped section, wherein the end face region (20, 200) comprises geometrically defined and/or geometrically undefined cutting edges (80a, 80b, 91) and wherein the working part (14, 140), in particular the tapering section (18, 180), comprises a first region (18a, 180a) with geometrically defined and/or geometrically undefined cutting edges (80a, 80b, 91) and at least a second, non-cutting region (18b, 180b), wherein the tapered section (18, 180) is configured such that it can remove a first time chip volume (ZSV₁) and the end face region (20, 200) is configured such that it can remove a second time chip volume (ZSV₂), and wherein the first time chip volume (ZSV₁) is greater than the second time chip volume (ZSV₂) at the same rotational speed (n_{F}) of the milling and/or grinding tool.

The present invention relates to a milling and/or grinding tool and a method for turning using a milling and/or grinding tool. In particular, the invention relates to a milling and/or grinding tool and a method for turning using such a milling and/or grinding tool for the manufacture of components for use within or near the human body, for example for the manufacture of elements for prosthetic dental care, such as so-called abutments or dental crowns, otoplastics, such as hearing protection or hearing aids, or other medical devices or components.

Publication EP 1 810 637 A1 describes a dental milling tool with a milling head attached to a shaft, which is essentially conical in configuration and provided with multiple cutting edges.

Publication WO 2013/164068 A1 describes a dental milling tool and a milling method for manufacturing dental prosthetic components. The dental milling tool comprises a hemispherical-shaped ball-head section that transitions into an axial cutting section, which extends in the axial direction with a constant diameter.

DE 10 2005 001 600 B4 discloses a method for the material-removing machining of workpieces, in which the workpiece is machined by engagement of a rotating milling tool that is at least partially cylindrical and/or truncated conical in cross-section, and wherein the rotating milling tool is brought into engagement with the workpiece both at the end face and on the side.

EP 3 332 737 B1 discloses a method for producing a dental restoration component using a dental machining machine that comprises a multi-axis workpiece arm and at least one tool spindle. During machining, the tool remains in continuous contact with the workpiece by machining the entire outer profile of the workpiece in a substantially helical manner. The dental machining machine is configured as a 5/0-axis milling machine, i.e., with five axes for the multi-axis workpiece arm and zero axes for the machining tool.

The object of the invention is to improve the manufacture of precision engineered or precision mechanical components, particularly for use within or near the human body and especially for prosthetic dental care, otoplastics, or other medical devices, and in particular the manufacture of abutments or dental crowns.

The task is solved according to the invention by a milling and/or grinding tool, in particular a dental milling or dental grinding tool, comprising a shaft and a working part, wherein the working part comprises at least a partially ball-shaped end face region and a section tapering toward the end face region, in particular a conically shaped section tapering toward the end face region, wherein the end face region comprises geometrically defined and/or geometrically undefined cutting edges, and wherein the working part, in particular the tapering section, comprises a first region with geometrically defined and/or geometrically undefined cutting edges and at least a second, non-cutting region, wherein the tapering section is configured such that it can remove a first time chip volume, wherein the end face region is configured such that it can remove a second time chip volume, and wherein the first time chip volume is greater than the second time chip volume at the same rotational speed of the milling and/or grinding tool.

A milling and/or grinding tool according to the invention enables an advantageous manufacturing process for producing components for use within or near the human body, in particular elements for prosthetic dental care, and in particular abutments. By shaping the working part with a section that tapers toward the end face region, the rigidity of the milling and/or grinding tool is increased to such an extent that a turning process becomes possible in which roughing and finishing can be performed in a single operation using the same tool. In other words, both the tapered section and the end face region can engage with the workpiece blank to remove material. The tapered section is configured to perform roughing with a relatively large chip volume to be removed, and the end section is configured to perform finishing or fine finishing with a relatively small chip volume to be removed. In this way, it is possible to simultaneously rough and finish a workpiece. The tapered section increases the rigidity of the milling and/or grinding tool to such an extent that the high loads during the simultaneous roughing and finishing operations can be withstood. Geometrically defined cutting edges are understood to be cutting edges whose geometry and number are known. Geometrically defined cutting edges can advantageously be produced by a laser machining process. Geometrically undefined cutting edges are understood to be cutting edges for which neither the geometry of the cutting edges nor their number is known.

An advantageous embodiment comprises a segment of the tapered section extending over a first axial length being configured such that it can remove the first time chip volume, and the end face region extending over a second axial length being configured such that it can remove the second time chip volume, wherein the first axial length and the second axial length are of equal length.

The tapered section and the end face region are thus configured such that the tapered section can remove a higher time chip volume over a first axial length or axial extent than the end face region over a second axial length or axial extent that is exactly as long as the first axial length or axial extent. This can be achieved, for example, by the end face region having fewer cutting edges in the region of the second axial length than the tapered section in the region of the first axial length, or by the cutting edges of the end face region in the region of the second axial length having a lower cutting capacity than the cutting edges of the tapered section in the region of the first axial length.

In a further advantageous embodiment, it is provided that the first region has geometrically defined cutting edges that are helically arranged around a tool longitudinal axis of the milling and/or grinding tool and are configured in particular as continuous, preferably without cross-cuts, and/or that the end face region comprises geometrically defined cutting edges. The geometrically defined cutting edges of the end face region may be helically wound around a tool longitudinal axis of the milling and/or grinding tool and, in particular, may be continuous, preferably without cross-cuts. Alternatively, the geometrically defined cutting edges of the end face region may also be configured, for example, in a straight line or curved radially away from the tool axis.

In this way, an advantageously designed milling cutter can be configured that meets high requirements for rigidity during operation.

Furthermore, it may be advantageous if the first region comprises exclusively geometrically undefined cutting edges, and/or that the end face region comprises exclusively geometrically undefined cutting edges.

In this way, an advantageous grinding tool, in particular in the form of a grinding pin, can be configured that meets the high requirements for rigidity during operation.

Likewise, it may be advantageous to provide a combined milling and/or grinding tool in which either the tapered section or the end face region comprises geometrically defined cutting edges and the other comprises geometrically undefined cutting edges. It is also possible for both geometrically defined cutting edges and geometrically undefined cutting edges to be provided in the tapered section and/or the end face region.

Furthermore, it may be advantageous for the tapered section to include the second, non-cutting region.

The provision of a non-cutting region within the tapered section can contribute to a further increase in tool rigidity.

In an advantageous embodiment, the end face region has a number N₁ of cutting edges and the tapered section has a number N₂ of cutting edges, wherein the number N₁ of cutting edges of the end face region is smaller than the number N₂ of cutting edges of the tapered section.

Due to the greater number of cutting edges, the tapered section allows for the removal of a large chip volume per unit of time, which is desirable during rough machining. In particular, this enables high cutting speeds. Due to the smaller number of cutting edges at the end face region, this section can remove or cut away only a smaller chip volume per unit of time. Likewise, the maximum achievable chip thickness is reduced. Thus, the partially ball-shaped end face region is advantageously configured for finishing operations, such as rough finishing or fine finishing.

Furthermore, it may be advantageous if the tapered section is a conically shaped section and has a cone angle of 2° to 7°, in particular 3° to 6°, preferably 5°, relative to the tool longitudinal axis of the milling and/or grinding tool.

Cone angles of 2° to 7°, in particular 3° to 6°, preferably 5° are particularly advantageous especially when the specified angles enable both an advantageous radius of the partially ball-shaped end face region and an advantageous cutting length, or an advantageous ratio of free shank length to cutting length of the milling and/or grinding tool for the cutting edges in the conical region.

As an alternative to a conical design, the tapered section may be concave or convex in shape, or may taper in a stepped or wavy manner, or may exhibit a hybrid form of these shapes.

Alternatively or additionally, it is possible for the tapered section to merge, in particular immediately, into the partially ball-shaped end face region in such a way that a substantially exactly hemispherical-shaped end face region is provided, or for the tapered section to merge into the partially ball-shaped end face region in such a way that an end face region configured essentially more than hemispherical-shaped is provided, or that the tapered section merges into the partially ball-shaped end face region such that an end face region configured essentially less than hemispherical-shaped is provided.

Additionally, the conically shaped section may have a cone base diameter of 2.3 mm to 3.8 mm, in particular 2.8 mm to 3.3 mm, preferably 3.0 mm or 3.033 mm.

With a cone base diameter within the specified values, a particularly good rigidity of the milling tool can be achieved.

Another advantageous embodiment is defined by the partially ball-shaped end face region having a ball radius of 0.5 mm to 1.2 mm, in particular 0.6 mm to 0.9 mm, preferably 0.7 mm.

With a radius within the specified values, very fine contours with high tolerance requirements can be produced. Such a radius is in particular advantageous in combination with an advantageous cone angle and/or an advantageous cutting length, or with an advantageous ratio of free shank length to cutting length of the milling and/or grinding tool.

Furthermore, it may be advantageous to provide a ratio of the free neck length of the milling and/or grinding tool to the cutting length of the milling and/or grinding tool of 2:1 to 1, in particular 3:2, 4:3, 5:4, 6:5, or 7:6.

An advantageous ratio of free shank length to cutting length provides high rigidity of the working area, so that, in particular when a force acts radially on the working area during operation, bending of the shank cutter is prevented or at least reduced. In particular, such a ratio is advantageous in combination with a favorable cone angle and/or a favorable radius of the partially ball-shaped end face region.

A further advantageous embodiment is defined by the fact that at least a limited surface area of the milling and/or grinding tool, in particular a limited surface area of the end face region, preferably a segment of an end face cutting edge or a rake face of the end face region or a clearance area of the end face region or a rake face or a clearance area of the tapered section, has an mean roughness value Rₐ of less than 0.4 μm or of less than 0.35 μm, and/or that at least a limited surface area of the milling and/or grinding tool, in particular a limited surface area of the end face region, preferably a segment of an end face cutting edge or a rake face of the end face region or a clearance area of the end face region, or a rake face or a clearance area of the tapered section has a mean roughness R_{Z} of less than 3.0 μm, preferably of less than 2.5 μm or 2.4 μm.

Workpieces with very high surface quality can be produced using milling and/or grinding tools configured in this manner.

The object of the invention is further solved by a turning system, in particular a turning-milling system, comprising a turning spindle and a milling spindle with a milling and/or grinding tool according to the invention.

Such a turning system, in particular a turning-milling system, enables a turning process, in particular a turning-milling process, for the manufacture of elements for prosthetic dental care, for otoplastics, or for medical devices using a milling and/or grinding tool according to the invention, in particular a dental milling tool designed and configured for use in a turning-milling process.

With such a turning system, in particular a turning-milling system, it is possible to manufacture precision engineered or precision mechanical components, in particular for use within or near the human body and especially for prosthetic dental care, for otoplastics, or for other medical devices and in particular dental prosthetic components, economically and with high quality.

The object of the invention is further achieved by a turning process, in particular a turning-milling process, for the manufacture of elements for prosthetic dental care, for otoplastics, or other medical devices using a milling and/or grinding tool, wherein the milling and/or grinding tool may be a milling and/or grinding tool according to the invention. The method according to the invention can be carried out in particular with a turning system, specifically a turning-milling system comprising a turning spindle and a milling spindle with a milling and/or grinding tool according to the invention.

The turning process of the invention comprises the following steps: rotating a workpiece blank about a workpiece rotation axis; rotating the milling and/or grinding tool about a tool rotation axis; inserting the rotating milling and/or grinding tool into the rotating workpiece blank to remove workpiece material by cutting;
machining the rotating workpiece blank in a single machining step by removing material from the workpiece in a first machining operation and in a second machining operation, wherein the workpiece blank is machined in the first machining operation to the extent of a first time chip volume and is machined in the second machining operation to the extent of a second time chip volume, wherein the first time chip volume is greater than the second time chip volume, and wherein the first machining operation and the second machining operation take place at least partially, in particular predominantly, preferably essentially completely, simultaneously; withdrawal of the rotating dental milling tool from the rotating workpiece.

The method of the invention makes it possible to produce a finished workpiece—for example, a dental prosthetic component—from a workpiece blank in a single, continuous machining step performed without interrupting the milling process. This machining step—i.e., the milling and/or grinding step—includes a first machining operation in which rough machining of the workpiece blank is performed, and a second machining operation in which finish machining is performed. In this process, the milling and/or grinding tool is inserted into the workpiece blank to remove material by cutting, and the workpiece blank is machined with a region of the milling and/or grinding tool capable of removing the first time chip volume and, preferably simultaneously, machined with another region of the milling and/or grinding tool capable of removing the second time chip volume. The region removing the first time chip volume may be the section of the milling and/or grinding tool—in particular, one according to the invention—that tapers in the direction toward the end face region, in particular conically shaped section of the milling and/or grinding tool—in particular, one according to the invention—and the region removing the second time chip volume may be the end face region of the milling and/or grinding tool—in particular, one according to the invention.

The first and second machining operations can thus be performed simultaneously, which enables a significant reduction in the total machining time of the workpiece. It is further possible that, throughout the entire machining step, the milling and/or grinding tool remains in machining engagement with the workpiece blank.

An advantageous embodiment further comprises that the first machining operation is performed, in particular exclusively, by the tapered section, and/or that the second machining operation is performed, in particular exclusively, by the partially ball-shaped end face region of the milling and/or grinding tool.

Thus, in the first machining operation, rough machining is performed using a region of the tool specifically designed for this task, namely the tapered, in particular conically shaped, region, and in the second machining operation, finish machining is performed using another region of the tool specifically designed for finish machining. In particular, in this embodiment of the method, the milling and/or grinding tool may remain in machining engagement with the workpiece blank throughout the entire machining step

Furthermore, it may be advantageous if, upon the rotating milling and/or grinding tool entering the rotating workpiece blank, the first machining operation begins first and, in particular immediately thereafter, the second machining operation begins, and/or that the first machining operation ends before or upon withdrawal from the rotating workpiece blank, and, in particular, the second machining operation ends immediately thereafter.

This can be achieved, for example, by advancing the tool toward the workpiece not along its longitudinal axis but in a lateral direction. Thus, during entry, for example, the tapered section of the tool can engage with the workpiece ahead of the end face region and perform roughing ahead of the end face region.

Furthermore, it may be advantageous to configure the process such that the tool rotation axis intersects the workpiece rotation axis during entry into the workpiece blank and/or during machining of the workpiece blank and/or during exit from the workpiece, or that the tool rotation axis is offset relative to the workpiece rotation axis when entering the workpiece blank and/or when machining the workpiece blank and/or when exiting the workpiece, or that the tool rotation axis is moved in a first entry phase relative to the workpiece rotation axis when entering the workpiece blank and/or when machining the workpiece blank, and is moved in a cutting orientation with the workpiece rotation axis in a second entry phase, and/or that, when retracting from the workpiece in a first retraction phase, the tool rotation axis is oriented intersecting the workpiece rotation axis, and in a second retraction phase, the tool rotation axis is moved into an orientation offset relative to the workpiece rotation axis.

The manner in which the milling and/or grinding tool—and in particular a dental milling tool—is brought into contact with or moved toward the workpiece blank, or moved away from or away from it, is very significant for machining quality. The advantageous approach and retraction strategies avoid high, sudden loads on the milling and/or grinding tool upon initial contact with the workpiece blank, thereby increasing quality while simultaneously reducing the load on the milling and/or grinding tool, which extends its service life.

Furthermore, it may be advantageous if the tool rotation axis is arranged perpendicular to the workpiece rotation axis when entering the workpiece blank and/or when machining the workpiece blank and/or when exiting the workpiece; or
that the tool rotation axis is arranged at a lead angle, in particular relative to the workpiece rotation axis, when entering the workpiece blank and/or when exiting the workpiece and/or during machining of the workpiece blank.

A tool rotation axis perpendicular to the workpiece rotation axis during the entry of the dental milling tool enables favorable transmission of the cutting force into the workpiece blank. Setting the dental milling tool at a lead angle enables an increase in cutting performance.

Furthermore, it may be advantageous for the workpiece to rotate at a speed n of 10 min⁻¹ to 200 min⁻¹, in particular at a speed n of 100 min⁻¹ to 160 min⁻¹, preferably at a speed n of 120 min⁻¹.

In this way, a favorable ratio of workpiece rotational speed to cutting speed of the dental milling tool on the workpiece blank can be achieved.

It may also be advantageous if, after the rotating milling and/or grinding tool has been withdrawn from the rotating workpiece, at least a limited surface area of the workpiece exhibits a mean roughness value Rₐ of less than 0.3 μm, in particular less than 0.2 μm, preferably less than 0.18 μm or 0.1 μm.

In this way, a workpiece exhibiting very low surface roughness can be produced in a single machining step. It is also possible to further machine the workpiece after completion of the method according to the invention, for example by means of a polishing step or a milling step using a milling cutter with a partially ball-shaped end face region having a smaller radius.

Advantageous embodiments and further developments according to the invention are apparent from the respective dependent patent claims and also from the following description.

The invention is further explained below with exemplary embodiments and with reference to the drawings. The following figures show, in each case in a schematic representation:

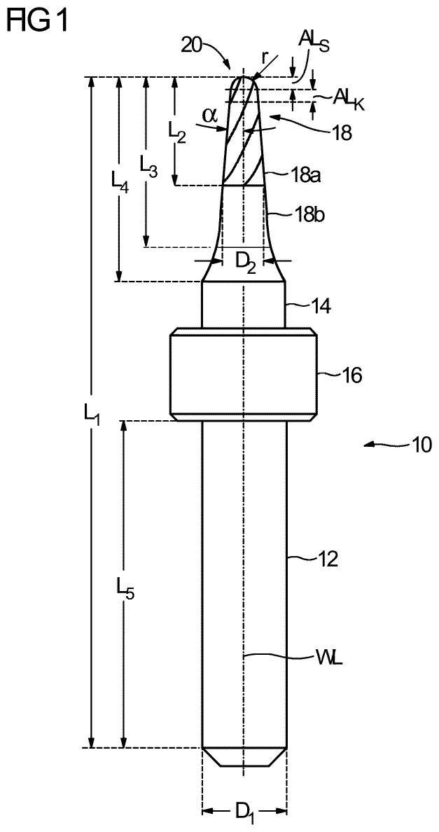

FIG. 1 shows a side view of a dental milling tool according to an embodiment of the invention;

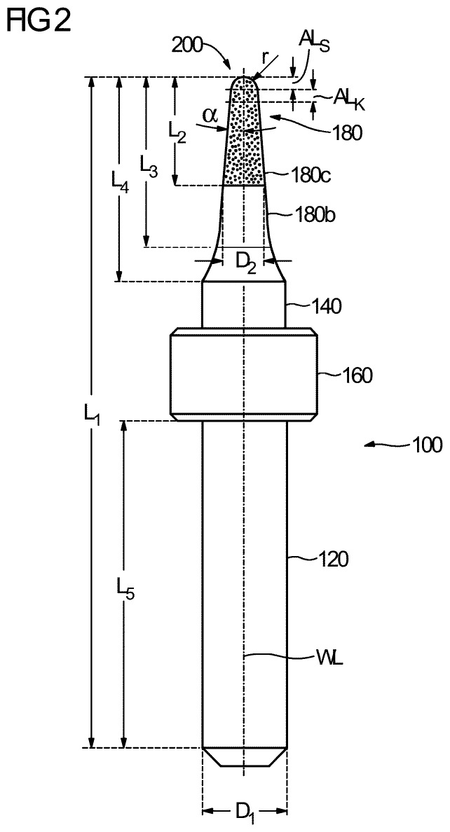

FIG. 2 shows a side view of a dental grinding pin according to an alternative embodiment of the invention;

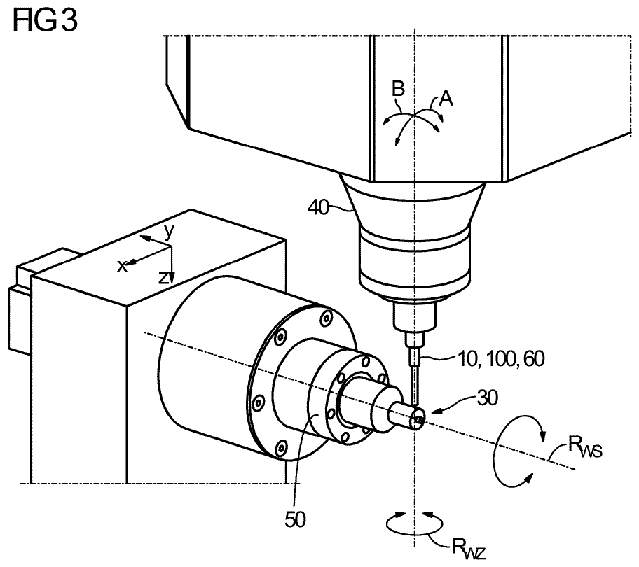

FIG. 3 shows a perspective view of a turning system for manufacturing dental prosthetic components;

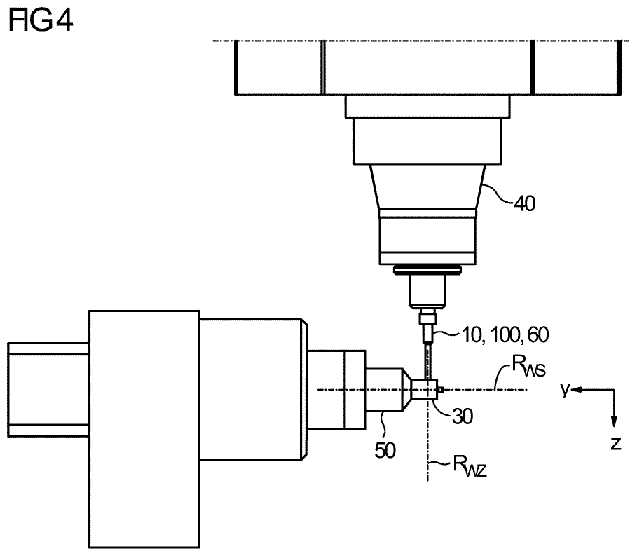

FIG. 4 shows a side view of the turning system of FIG. 3;

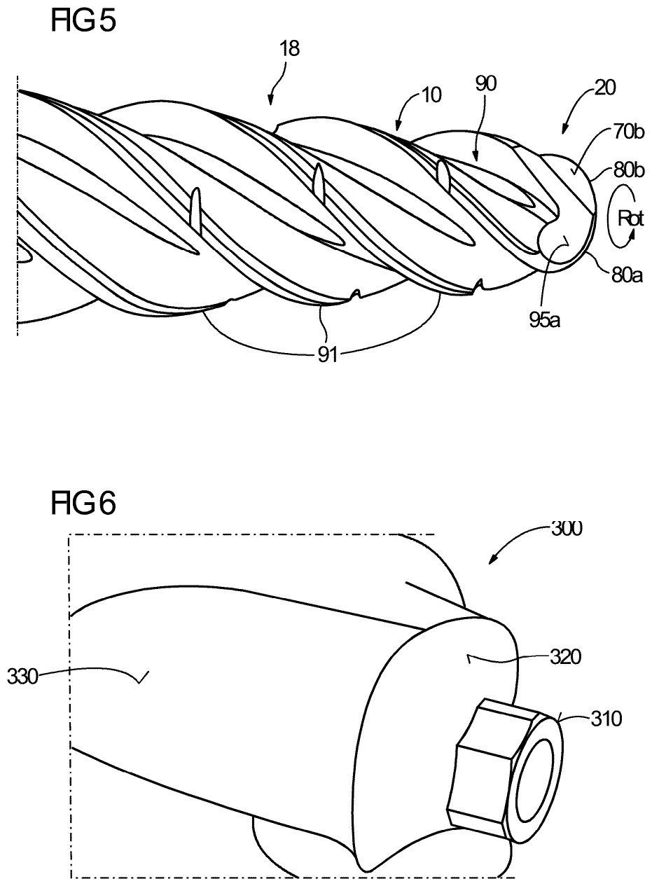

FIG. 5 shows a perspective view of a dental milling tool according to an embodiment of the invention;

FIG. 6 shows a perspective view of an abutment producible using the tool or method of the invention;

FIGS. 5 and 6 each show schematic illustrations that are not suitable for determining sizes or dimensions by measurement.

FIG. 1 shows a dental milling tool 10 designed as a shank milling tool, comprising a shaft 12 and a working part 14. The working part 14 has a conically shaped section 18, which is configured with a partially ball-shaped end face region 20 at a front end. More specifically, the conically shaped portion of the conical section transitions directly into a partially ball-shaped shape, thereby forming the front end of the dental milling tool 10, which thus has a partially ball-shaped end face 20. In the embodiments shown in FIGS. 1 and 2, the conically shaped section 18 transitions into the partially ball-shaped end face region 20 in such a way that a ball-shaped end face region substantially less than hemispherical-shaped is provided.

Alternative embodiments are possible in which, instead of the depicted conically shaped section 18, a section tapering in a different manner is configured, in which there is no conical shape or at least no exclusively conical shape. In such embodiments, it is possible for the tapering section to merge into the partially ball-shaped end face region 20 in such a way that an end face region 20 configured substantially exactly as a hemispherical-shaped region is provided, or that the tapered section merges into the partially ball-shaped end face region 20 such that an end face region 20 configured substantially more than a hemispherical-shaped region is provided.

The conically shaped section 18 comprises a region 18a with cutting edges that are helically arranged around a tool longitudinal axis WL of the dental milling tool 10. The cutting edges are configured to be continuous or uninterrupted, meaning the cutting edges have no breaks or notches and, in particular, no cross-cuts. The cutting edges have a cutting length L₂ of, for example, 8 mm.

The cutting region 18a of the conical section is immediately followed by a non-cutting region 18b. The total length of the conical section, the so-called free neck length L₃, comprises the cutting length L₂ as well as the length of the non-cutting region 18b and may, for example, be 10 mm.

The front region of the shank cutter 10 adjoining the shaft 12 has a shaft connection length L₄, which may, for example, be 15 mm.

The free neck length L₃ may have a ratio to the cutting length L₂ of 2:1 to 1, in particular 3:2, 4:3, 5:4, 6:5, or 7:6. In particular, the cutting length L₂ may be 8 mm.

The end face region 20 has a number N₁ of cutting edges, while the conically shaped section 18 has a number N₂ of cutting edges. The number N₁ of cutting edges of the end face region 20 may be the same as the number N₂ of cutting edges of the section 18; it is also possible for the end face region 20 to have a smaller number N₁ of cutting edges than section 18. For example, the end face region may have a number N₁ of 2 to 4 cutting edges, and section 18 may have a number N₂ of 3 to 6 cutting edges. For some applications, a number N₁ of 2 and a number N₂ of 4, as shown in the illustrated embodiment, are advantageous.

The cutting edges of the conically shaped section 18 are helically wound around the tool longitudinal axis WL of the dental milling tool and are configured to extend circumferentially and continuously. In the illustrated embodiment, a twist angle or spiral angle of 45° is provided for the cutting edges. The twist or spiral direction is right-handed; accordingly, the dental milling tool is configured for a right-handed cutting direction.

In addition, the cutting edges are equally spaced, i.e., the distance between the cutting edges in the circumferential direction of the tool is the same in each case.

The shaft of the dental milling tool may comprise or consist of carbide; the working part 14 and/or the cutting edges may be provided with a TiAlN (titanium aluminum nitride) coating.

Furthermore, the conically shaped section 18 may have a cone angle α of 2° to 7°, in particular 3° to 6°, relative to the tool longitudinal axis WL of the dental milling tool. In the illustrated embodiment, the conically shaped section 18 has a cone angle of 5°. In addition, the conically shaped section 18 may have a cone base diameter D₂ of 2.3 mm to 3.8 mm, in particular 2.8 mm to 3.3 mm, preferably 3.0 mm. In the illustrated embodiment, the cone base diameter D₂ is 3.033 mm.

The partially ball-shaped end face region 20 may have a ball radius r of 0.5 mm to 1.2 mm, in particular 0.6 mm to 0.9 mm. The illustrated embodiment has a ball radius r of 0.7 mm.

The shaft 12 has a shaft diameter D₁ of 6 mm and a shaft length of 25 mm. The total length of the dental milling tool 10 may, for example, be 50 mm. To simplify automatic tool changing, a stop ring 16 is provided on the dental milling tool.

FIG. 2 shows an alternative embodiment featuring a grinding tool configured as a shank tool, specifically a grinding pin 100. The grinding pin 100 has essentially the same shape and dimensions as the dental milling tool 10. However, in the cutting region 180a and the end face region 200, the grinding pin 100 features abrasives instead of geometrically defined, twisted cutting edges; these abrasives have or represent geometrically undefined cutting edges, for example in the form of diamond grains that are bonded to the working part 14 of the grinding pin via a carrier matrix or by other suitable means.

Unillustrated embodiments include a combined milling and/or grinding tool that, for example, in the cutting region 18a, 180a, features geometrically defined cutting edges helically arranged around the tool longitudinal axis WL of the dental milling tool, and in the end face region 20, 200, abrasives with a defined grit size, i.e., geometrically undefined cutting edges. It is also conceivable that abrasives are provided in the cutting region 18a, 180a and geometrically defined cutting edges in the end face region 20, 200.

Furthermore, FIGS. 1 and 2 show that a segment of the conically shaped section 18 extends over a first axial length AL_{K}. This segment is configured such that a first time chip volume ZSV₁ can be removed with it. In addition, the end face region 20 extends over a second axial length AL_{S}, which is exactly as long as the first axial length AL_{K}. The end face region 20 is configured such that it can remove a second time chip volume ZSV₂. When the aforementioned segment of the conically shaped section 18 and the end face region 20 are simultaneously in cutting engagement with the workpiece, both regions rotate at the same rotational speed n_{F}. During the same period, the segment of the conically shaped section 18 removes a greater chip volume than the end face region 20. This allows the conically shaped section 18 to perform roughing operations while the end face region 20 performs finishing operations simultaneously.

FIGS. 3 and 4 show a perspective view and a side view of a rotary milling system for the manufacture of dental prosthetic components. The milling cutter 60 shown in FIGS. 3 and 4 corresponds to an exemplary milling cutter. The described turning-milling system can also advantageously be equipped with a dental milling tool according to the invention, such that the milling cutter 60 can be replaced by a dental milling tool 10 or a grinding pin 100.

The rotary milling system comprises a milling spindle 40 and a turning spindle 50, which are arranged orthogonally to one another. A workpiece 30 in the form of a blank is clamped into the turning spindle 50, such that the workpiece 30 can be rotated by the turning spindle 50 about a workpiece rotation axis RWS. The workpiece blank is to be machined into a workpiece 30 with predefined end dimensions, more specifically a so-called abutment. Abutments are typically referred to as connecting elements between a dental implant, such as a tooth root replacement, and the prosthetic restoration, such as the visible dental crowns. Abutments are typically made of titanium, aluminum oxide ceramic, or zirconium dioxide ceramic.

The milling cutter 60 is mounted in the milling spindle 40 so that the milling cutter 10 can rotate about a tool rotation axis R_{WZ}. The directions of rotation of the workpiece 30 and the milling cutter 10 may be opposite.

For example, when using the milling cutter 10 from FIG. 1, which has a clockwise rotation as its predetermined cutting direction, the milling spindle 40 is operated in a clockwise direction, while the turning spindle 50 is operated in a counterclockwise direction. In this way, the workpiece blank is rotated “into” the rotating milling cutter 10, thereby performing a counter-rotational machining operation.

The workpiece rotation axis R_{WS} is oriented parallel to the y-axis of a Cartesian coordinate system or, as in the situation shown in FIGS. 3 and 4, coincides with the y-axis. The tool rotation axis R_{WZ} is parallel to a z-axis of the Cartesian coordinate system or, as in the situation shown in FIGS. 3 and 4, coincides with the z-axis.

The workpiece rotation axis R_{WS} and the tool rotation axis R_{WZ} are shown as being arranged orthogonally to one another, wherein the milling spindle 40 can additionally pivot about two rotary axes A and B around the z-axis, and the milling spindle 40 itself can be rotated about the y-axis. The turning spindle 50 also allows the workpiece 30 to be advanced in the direction of the y-axis.

The turning-milling system configured in this way enables a turning-milling process in which a workpiece blank rotates around the workpiece rotation axis R_{WS}, similar to a turning process. The rotating workpiece blank 30 is machined by the milling cutter 60, which rotates about its tool rotation axis R_{WZ}, whereby the rotating milling cutter 60 enters the rotating workpiece blank 30 along a defined entry path to remove workpiece material.

In the illustrated embodiment, during entry into the workpiece blank 30 or during exit from the workpiece, the workpiece rotation axis R_{WS} intersects the tool rotation axis R_{WZ}. More precisely, for this purpose, the milling cutter 10, 60 is arranged such that the tool rotation axis R_{WZ} intersects the workpiece rotation axis R_{WS}. In this arrangement, the milling cutter 10, 60 can be fed into the workpiece 30 along the workpiece rotation axis R_{WS}, or along the y-axis.

Alternatively, with the rotary milling system, the tool rotation axis R_{WZ} may be oriented offset relative to the workpiece rotation axis R_{WS} when entering the workpiece blank and/or when exiting the workpiece.

Likewise, a variable setting is possible such that the tool rotation axis R_{WZ} is moved in an offset orientation relative to the workpiece rotation axis R_{WS} during a first entry phase when entering the workpiece blank and is moved in a cutting orientation with the workpiece rotation axis R_{WS} during a second entry phase, or such that the tool rotation axis R_{WZ} is moved intersecting the workpiece rotation axis R_{WS} during a first withdrawal phase and is moved in an orientation offset relative to the workpiece rotation axis R_{WS} during a second withdrawal phase.

The special shape of the milling cutter 10 or the grinding pin 100 makes it possible for the conically shaped section 18 to machine the rotating workpiece blank 30 with a first time chip volume ZSV₁ and the end face region 20 can machine the rotating workpiece blank 30 with a second time chip volume ZSV₂ in a second machining operation. The first and second machining operations can be performed simultaneously due to the special design of the milling cutter 10 or the grinding pin 100.

Furthermore, in the embodiment shown in FIGS. 3 and 4, the tool rotation axis R_{WZ} is arranged perpendicular to the workpiece rotation axis R_{WS} when entering the workpiece blank 30 or when exiting the finished workpiece. Alternatively, the tool rotation axis R_{WZ} may be arranged at an lead angle, in particular relative to the workpiece rotation axis R_{WS}, when entering the workpiece blank 30, when exiting the workpiece, or during machining of the workpiece blank 30. The lead angle is defined as the angle by which the milling cutter 10, 60 is inclined in the feed direction. The lead angle may be selected to be less than 90°. More precisely, the lead angle denotes the angle between the surface normal of the machined area and the tool orientation, in the direction of the path tangent of the tool's feed path.

The lead angle serves to orient the tool at a fixed approach angle to the machining plane. This allows the cutting performance to be increased. For example, when aligned vertically, a ball-end miller contacts the area to be machined precisely with the tool tip. At this point on the milling cutter, however, the rotational speed—and thus also the cutting speed—is 0.

The workpiece 30 is rotated by the turning spindle 50 at a rotational speed n of 10 min⁻¹ to 200 min⁻¹, in particular at a rotational speed n of 100 min⁻¹ to 160 min⁻¹, preferably at a rotational speed n of 120 min⁻¹.

Using the described turning process, and in particular the turning-milling process, workpieces, such as abutments, with diameters typically ranging from 2 mm to 10 mm can be machined. When machining non-circular workpieces, the milling and/or grinding tool can, for example, be adjusted in the z-direction such that roughing is performed by the tapered section 18, 180 leading the tool, and finishing is performed by the end face region 20, 200 trailing the tool. Alternatively or additionally, it is possible to position or guide the milling and/or grinding tool at such an angle to the workpiece surface that rough machining is performed by the tapered section 18, 180 and finish machining by the end face region 20, 200.

FIG. 5 shows a perspective view of the dental milling tool 10 with a partially ball-shaped end face region 20, which has two end face cutting edges 80a, 80b. In the view shown, a rake face 70b associated with the end face cutting edge 80b and a clearance area 95a associated with the end face cutting edge 80a are visible. In the end face region 20 facing away from the observer, an additional rake face and an additional clearance area are provided. Chip spaces 90 are defined in the helical grooves between the cutting edges 91 of the conically shaped section 18.

It may be advantageous if at least a limited surface area of the milling and/or grinding tool, in particular a limited surface area of the end face region 20, preferably a segment of an end face cutting edge 80a, 80b or a rake face 70b of the end face region 20, or a clearance area 95a of the end face region 20, as well as a rake face or clearance area of the tapered section 18, has a mean roughness value Rₐ of less than 0.4 μm or less than 0.35 μm.

It may also be advantageous if at least a limited surface area of the milling and/or grinding tool, in particular a limited surface area of the end face region 20, preferably a segment of an end face cutting edge 80a, 80b or a rake face 70b of the end face region 20, or a clearance area 95a of the end face region 20—including a rake face or clearance area of the tapered section 18—has a mean roughness depth R_{Z} of less than 3.0 μm, preferably of less than 2.5 μm or 2.4 μm.

FIG. 6 shows a perspective view of an abutment 300 producible using the tool or method of the invention.

It may be advantageous if at least a limited surface area of the workpiece, for example a limited surface area or a complete handling surface area, such as a polygonal surface configured for anti-rotation lock 310, a front area 320, or a side area 330 of the abutment 300, has an arithmetic mean roughness value Rₐ of less than 0.3 μm, in particular of less than 0.2 μm, preferably of less than 0.18 μm or 0.1 μm.

Likewise, it may be advantageous if at least a limited surface area of the workpiece, for example a limited area or a complete handling area, such as an anti-rotation lock surface 310, a front area 320, or a side area 330 of the abutment 300, exhibits a mean roughness R_{Z} of less than 1 μm, in particular less than 0.9 μm, preferably less than 0.7 μm or 0.6 μm or 0.5 μm.

In this way, a workpiece exhibiting very low surface roughness can be produced in a single machining step. It is also possible to further machine the workpiece after completion of the method according to the invention, for example by means of a polishing step or a milling step using a milling cutter with a partially ball-shaped end face region having a smaller radius.

### List of Reference Signs

10 dental milling tool
100 dental grinding tool
12, 120 shaft
14, 140 working part
16, 160 stop ring
18, 180 conical section
18a, 180a cutting region
18b, 180b non-cutting region
20, 200 end face region
30, 300 workpiece
40 milling spindle
50 turning spindle
60 milling cutter
70b rake face
80a, 80b end face cutting edges
90 chip space
91 cutting edges of the conical section
95a clearance area
300 workpiece
310 area for anti-rotation lock
320 front area
330 side area
L₁ total length
L₂ cutting length
L₃ free neck length
L₄ shaft connection length
L₅ shaft length
D₁ shaft diameter
D₂ cone base diameter
r ball radius
WL tool longitudinal axis
α cone angle
R_{WZ} rotation axis of the tool
R_{WS} rotation axis of the workpiece
Rot rotation direction of the tool
n_{F} rotational speed of the milling tool
x, y, z linear axes
A, B rotary axes
Rₐ arithmetic mean roughness value
R_{Z} mean roughness
AL_{K} first axial length
AL_{S} second axial length

What is claimed:

1. Milling and/or grinding tool, in particular a dental milling or dental grinding tool (10, 100), comprising a shaft (12, 120, 140) and a working part (14, 140), wherein the working part (14, 140) has at least one partially ball-shaped end face region (20, 200) and a section (18, 180) tapering toward the end face region (20, 200), in particular a conically shaped section, wherein the end face region (20, 200) comprises geometrically defined and/or geometrically undefined cutting edges (80a, 80b, 91) and wherein the working part (14, 140), in particular the tapering section (18, 180), comprises a first region (18a, 180a) with geometrically defined and/or geometrically undefined cutting edges (80a, 80b, 91) and at least a second, non-cutting region (18b, 180b), wherein the tapered section (18, 180) is configured such that it can remove a first time chip volume (ZSV₁) and the end face region (20, 200) is configured such that it can remove a second time chip volume (ZSV₂), and wherein the first time chip volume (ZSV₁) is greater than the second time chip volume (ZSV₂) at the same rotational speed (n_{F}) of the milling and/or grinding tool.

2. Milling and/or grinding tool according to claim 1, characterized in that a segment of the tapered section (18, 180) extending over a first axial length (AL_{K}) is configured such that it can remove the first time chip volume (ZSV₁), and wherein the end face region (20, 200) extending over a second axial length (AL_{S}) is configured such that it can remove the second time chip volume (ZSV₂), wherein the first axial length (AL_{K}) and the second axial length (AL_{S}) are of equal length.

3. Milling and/or grinding tool according to claim 1, characterized in that the first region (18a, 180a) comprises geometrically defined cutting edges (91) that are configured helically around a tool longitudinal axis (WL) of the milling and/or grinding tool in a circumferential and, in particular, continuous manner, preferably without cross-cuts, and/or
that the end face region (20) comprises geometrically defined cutting edges (80a, 80b), in particular wherein the geometrically defined cutting edges (80a, 80b) are configured to be helically wound around a tool longitudinal axis (WL) of the milling and/or grinding tool and, in particular, continuous, preferably without cross-cuts.

4. Milling and/or grinding tool according to claim 1, characterized in that the first region (18a, 180a) comprises exclusively geometrically undefined cutting edges, and/or
that the end face region (20, 200) comprises exclusively geometrically undefined cutting edges.

5. Milling and/or grinding tool according to claim 1, characterized in that the tapered section (18, 180) comprises the second, non-cutting region (18b, 180b).

6. Milling cutter and/or grinding tool according to claim 1, characterized in that the end face region (20, 200) has a number N₁ of cutting edges and that the tapered section (18, 180) has a number N₂ of cutting edges, wherein the number N₁ of cutting edges of the end face region (20, 200) is smaller than the number N₂ of cutting edges of the tapered section (18, 180).

7. Milling and/or grinding tool according to claim 1, characterized in that the tapered section (18, 180) is a conically shaped section (18, 180) and has a cone angle (α) of 2° to 7°, in particular 3° to 6°, preferably 5°, relative to the tool longitudinal axis (WL) of the milling and/or grinding tool.

8. Milling and/or grinding tool according to claim 7, characterized in that the conically shaped section (18, 180) has a cone base diameter (D₂) of 2.3 mm to 3.8 mm, in particular of 2.8 mm to 3.3 mm, preferably of 3.0 mm or 3.033 mm.

9. Milling and/or grinding tool according to claim 1, characterized in that the partially ball-shaped end face region (20, 200) has a ball radius (r) of 0.5 mm to 1.2 mm, in particular of 0.6 mm to 0.9 mm, preferably of 0.7 mm.

10. Milling and/or grinding tool according to claim 1, characterized in that a ratio of a free neck length (L₃) of the milling and/or grinding tool to a cutting length (L₂) of the milling and/or grinding tool of 2:1 to 1, in particular 3:2, 4:3, 5:4, 6:5, or 7:6.

11. Milling and/or grinding tool according to claim 1, characterized in that at least a limited surface area of the milling and/or grinding tool, in particular a limited surface area of the end face region (20, 200), preferably a segment of an end face cutting edge (80a, 80b) or a rake face (70b) of the end face region (20, 200) or a clearance area (95a) of the end face region (20, 200) or a rake face or a clearance area of the tapered section (18, 180) has a mean roughness value (Rₐ) of less than 0.4 μm or of less than 0.35 μm, and/or
that at least a limited surface area of the milling and/or grinding tool, in particular a limited surface area of the end face region (20, 200), preferably a segment of an end face cutting edge (80a, 80b) or a rake face (70b) of the end face region (20, 200) or a clearance area (95a) of the end face region (20, 200) or a rake face or a clearance area of the tapered section (18) has a mean roughness (R_{Z}) of less than 3.0 μm, preferably of less than 2.5 μm or 2.4 μm.

12. Turning system, in particular a turning-milling system, comprising a turning spindle (50) and a milling spindle (40) with a milling and/or grinding tool according to claim 1.

13. Turning process, in particular a turning-milling process, for example for the manufacture of elements for prosthetic dental care, for otoplastics, or for medical devices, using a milling and/or grinding tool, in particular a milling and/or grinding tool according to claim 1, comprising the following steps:
rotating a workpiece blank (30, 300) about a workpiece rotation axis (R_{WS});
rotating the milling and/or grinding tool about a tool rotation axis (R_{WZ});
feeding the rotating milling cutter and/or grinding tool into the rotating workpiece blank (30, 300) to remove workpiece material by machining;
machining the rotating workpiece blank (30, 300) in a single machining step by removing material from the workpiece in a first machining operation and in a second machining operation, wherein the workpiece blank (30, 300) is machined in the first machining operation to the extent of a first time chip volume (ZSV₁) and in the second machining operation within the scope of a second time chip volume (ZSV₂), wherein the first time chip volume (ZSV₁) is greater than the second time chip volume (ZSV₂) and wherein the first machining operation and the second machining operation take place at least partially, in particular predominantly, preferably essentially completely, simultaneously;
withdrawal of the rotating milling and/or grinding tool from the rotating workpiece.

14. Turning process according to claim 13, wherein the first machining operation is performed, in particular exclusively, by a tapered section (18, 180) of the milling cutter and/or wherein the second machining operation is performed, in particular exclusively, by the partially ball-shaped end face region (20, 200) of the milling and/or grinding tool.

15. Turning process according to claim 13, characterized in that, upon the rotating milling and/or grinding tool entering the rotating workpiece blank (30, 300), the first machining operation begins first and, in particular immediately, the second machining operation begins thereafter, and/or
that the first machining operation ends before or upon withdrawal from the rotating workpiece, and the second machining operation ends, in particular immediately thereafter.

16. Turning process according to claim 13, characterized in that the tool rotation axis (R_{WZ}) intersects the workpiece rotation axis (R_{WS}) when entering the workpiece blank and/or when machining the workpiece blank and/or when exiting the workpiece, or
that the tool rotation axis (R_{WZ}) is oriented offset relative to the workpiece rotation axis (R_{WS}) when entering the workpiece blank and/or when machining the workpiece blank and/or when exiting the workpiece, or
that the tool rotation axis (R_{WZ}) is moved in an offset orientation relative to the workpiece rotation axis (R_{WS}) during entry into the workpiece blank and/or during machining of the workpiece blank in a first movement phase, and is moved into a cutting orientation with the workpiece rotation axis (R_{WS}) and/or that during machining of the workpiece blank and/or during retraction from the workpiece in a third travel phase, the tool rotation axis (R_{WZ}) is oriented intersecting the workpiece rotation axis (R_{WS}), and in a fourth travel phase, the tool rotation axis (R_{WZ}) is moved into an orientation offset relative to the workpiece rotation axis (R_{WS}).

17. Turning process according to claim 13, characterized in that the tool rotation axis (R_{WZ}) is arranged perpendicular to the workpiece rotation axis (R_{WS}) during entry into the workpiece blank (30, 300) and/or during machining of the workpiece blank (30, 300) and/or during exit from the workpiece; or
that the tool rotation axis (R_{WZ}) is arranged at a lead angle, in particular relative to the workpiece rotation axis (R_{WS}), when entering the workpiece blank (30, 300) and/or when exiting the workpiece and/or during machining of the workpiece blank (30, 300).

18. Turning process according to claim 13, characterized in that the workpiece rotates at a rotational speed n of 10 min⁻¹ to 200 min⁻¹, in particular at a rotational speed n of 100 min⁻¹ to 160 min⁻¹, preferably at a rotational speed n of 120 min⁻¹.

19. Turning process according to claim 13, characterized in that at least one defined surface area of the workpiece, after the rotating milling and/or grinding tool has been withdrawn from the rotating workpiece, exhibits a mean roughness value (Rₐ) of less than 0.3 μm, in particular of less than 0.2 μm or of less than 0.18 μm.
